(19) United States
(12) Patent Application Publication
(10) Pub. No.: US 2026/0067289 A1
(43) Pub. Date: Mar. 5, 2026

(54) MASKING HIGH SECURITY MESSAGES ON COMPANION DEVICES

(71) Applicant: WhatsApp, LLC, Menlo Park, CA (US)

(72) Inventors: Bharath Kumar Avva Ramamurthy, San Jose, CA (US); Tomasz Odrobny, Dublin, CA (US); Nitin Asokan, Santa Clara, CA (US); Aditi Mathur, Alameda, CA (US); Weiwei Chen, Calgary (CA); Nathan Roberts, Gallatin Gateway, MT (US)

(73) Assignee: WhatsApp, LLC, Menlo Park, CA (US)

(21) Appl. No.: 19/308,853

(22) Filed: Aug. 25, 2025

Related U.S. Application Data
(60) Provisional application No. 63/688,664, filed on Aug. 29, 2024.

(51) Int. Cl. H04L 9/40; H04L 9/08

(52) U.S. Cl. CPC H04L 63/123; H04L 9/0863

(57) ABSTRACT

A system and method for selectively delivering sensitive messages to primary and companion devices associated with a user account. When a message containing sensitive information is received, it may be delivered to a designated primary device. After confirming delivery to the primary device, a placeholder message may be sent to companion devices, notifying the user of the sensitive message without revealing its contents.

### CROSS-REFERENCE TO RELATED APPLICATIONS

This application claims priority to and benefit of U.S. provisional patent application No. 63/688,664 filed Aug. 29, 2024, which is herein incorporated by reference.

### BACKGROUND

With the proliferation of mobile devices, many users now access their messaging accounts from multiple devices, including smartphones, tablets, computers, and wearable devices. While this multi-device access provides convenience, it also raises security and privacy concerns, particularly for sensitive messages such as one-time passwords (OTPs) or financial transaction notifications.

### BRIEF DESCRIPTION OF THE DRAWINGS

FIG. 1A illustrates an exemplary system for selective delivery of sensitive messages to primary and companion devices.

FIG. 1B illustrates an exemplary system for selective delivery of sensitive messages to primary and companion devices.

FIG. 2 is an example method for processing and delivering sensitive messages from a server perspective.

FIG. 3 is an example of a primary device and a companion device message.

FIG. 4 is an example method for handling received messages from a client device perspective.

FIG. 5 illustrates an example block diagram of an exemplary computing device suitable for implementing aspects of the disclosed subject matter.

The detailed description is set forth with reference to the accompanying drawings. The drawings are provided for purposes of illustration only and merely depict example embodiments of the disclosure. The drawings are provided to facilitate understanding of the disclosure and shall not be deemed to limit the breadth, scope, or applicability of the disclosure. The use of the same reference numerals indicates similar, but not necessarily the same or identical components. Different reference numerals may be used to identify similar components. Various embodiments may utilize elements or components other than those illustrated in the drawings, and some elements and/or components may not be present in various embodiments. The use of singular terminology to describe a component or element may, depending on the context, encompass a plural number of such components or elements and vice versa.

### DETAILED DESCRIPTION

Some embodiments of the present invention will now be described more fully hereinafter with reference to the accompanying drawings, in which some, but not all embodiments of the invention are shown. Various embodiments of the invention may be embodied in many different forms and should not be construed as limited to the embodiments set forth herein. Like reference numerals refer to like elements throughout.

It is to be understood that the methods and systems described herein are not limited to specific methods, specific components, or to particular implementations. It is also to be understood that the terminology used herein is for the purpose of describing particular embodiments only and is not intended to be limiting.

Described herein are systems and methods for masking high security messages on companion devices. That is, the high security messages (also referred to as “sensitive messages,” or the like, herein) are only transmitted to a primary device associated with a user account, and placeholder messages that do not contain the sensitive information in the high security messages are instead transmitted to any companion devices associated with the user account. Some messaging systems may synchronize all messages across all devices associated with a user account. This synchronization provides convenience for a user, as they can view messages on any of their devices that are associated with the messaging system. This synchronization, however, may lead to security vulnerabilities, such as unauthorized access to sensitive information on less secure companion devices. Additionally, the synchronization may compromise privacy in situations where companion devices are shared among family members (or other groups of multiple users).

The systems and methods may be applicable to a messaging system that allows users to exchange messages using messaging applications installed on different client devices. For example, two users may use the messaging system to exchange messages and/or a business may establish an account to allow users to interact with the business (e.g., message the business via the messaging service, perform transactions with the business, etc.). The messaging system may also be used for other communications between any other users and/or entities or any number of users and/or entities.

As one example of the downsides of message synchronization, a first user (such as a parent) may intend to perform a purchase through a business using the messaging system. The business may implement a one-time password (OTP) procedure to verify the first user's identity for increased security. The first user may be performing this transaction via a first device (e.g., a smartphone of the parent). At the same time, a second user may be using a second device that is also associated with the user account and recognized by the messaging system. For example, a child of the parent may be playing a game on a tablet. If the OTP is sent to all of the devices associated with the account, then the OTP would also be sent to the tablet in this scenario, and the child would then have access to the code and the ability to complete the transaction. This illustrates one scenario in which an OTP (a type of sensitive information) may be received by an unintended user, who may then use the code. In some instances, this may even result in such codes being received by users with malicious intent. For example, a malicious actor may steal or otherwise obtain access to one of the companion devices and may use the companion device to obtain an OTP to perform a purchase using another user's account. The OTP is merely one example of a type of sensitive information, and the same principle may apply to any other type of sensitive information that may be transmitted to the client devices via the messaging system. Accordingly, there is a need for a messaging system that can intelligently handle sensitive messages, ensuring they are delivered securely to a user's primary device while maintaining privacy on companion devices.

The disclosed subject matter may address security or privacy concerns associated with delivering sensitive messages to multiple devices linked to a single user account. By intelligently routing sensitive content only to a designated primary device and providing non-sensitive notifications to companion devices, the system may enhance security while maintaining a seamless user experience across devices. Continuing the exemplary use case mentioned above, the messaging system may send the actual OTP to the primary device and may send indications for any companion devices (devices other than the primary device) to display a message indicating that a user should view the messaging application on the primary device to obtain the OTP.

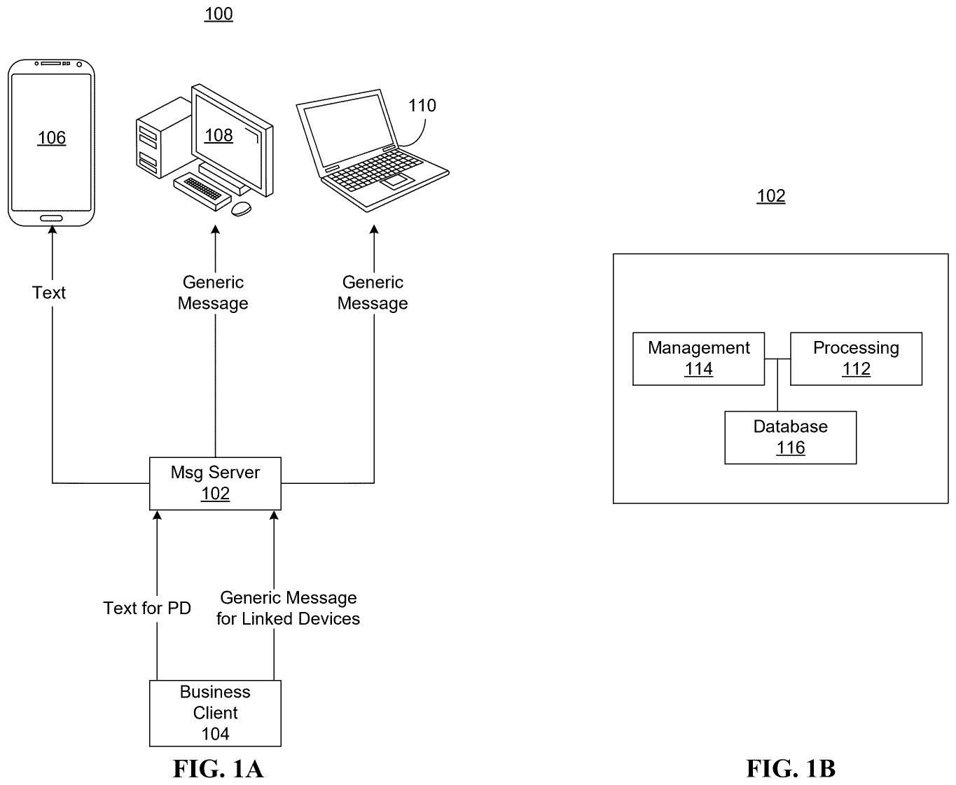

Turning to the figures, FIG. 1A illustrates an exemplary system 100 for implementing the disclosed subject matter (it should be noted that the configuration of the system 100 shown in FIG. 1A is not intended to be limiting and any other elements may be included in the system 100). The system 100 may include a messaging server 102 connected with multiple client devices. The messaging server 102 may be associated with a messaging system that allows users to transmit and receive messages via a messaging application installed on the various client devices. In some cases, multiple client devices may be linked to a single user account, such that messages may generally be accessed from multiple client devices. For example, if a user of the messaging system owns a smartphone and a tablet, both of which have the messaging application installed, it may be desirable for the user to be able to view and send messages from either device, depending on which device they are currently using (for convenience purposes).

Specifically, in embodiments, multiple client devices may be associated with a user account, which includes a primary device 106 and may include one or more companion devices (also referred herein as linked devices or secondary devices), such as companion device 108 or companion device 110. The companion device 108, companion device 110, or primary device 106 may include a tablet, desktop computer, head-mounted display, or wearable device, among other devices. Although FIG. 1A specifically shows three client devices, with each client device as a specific type of device, FIG. 1A is merely exemplary and not intended to limit the scope of the system 100 in any way. For example, there may be any other number of companion devices associated with a user account, and the primary device 106 and the companion devices may be any combination of different types of devices.

In embodiments, the primary device 106 may be the device on which the user account was initially created for the messaging system (however, the primary device 106 may be established in any other suitable manner). In some instances, the messaging system may also allow a user to reconfigure a different device 106 to be the primary device in place of the original primary device 106. The messaging system may also allow the user to add additional devices as companion devices (for example, via the messaging application installed on the primary device 106 or through any other suitable mechanism).

In embodiments, the user may designate one or more devices as companion devices 108 by accessing settings of the messaging application via the primary device 106. However, other devices may be added as companion devices or otherwise recognized by the server 102 as companion devices in any other suitable manner. For example, a user may login to the user account on a device other than the primary device 106. The server 102 may then prompt the user to indicate whether the new device should be saved as a companion device by the server 102. In some cases, the server 102 may also automatically store the device as a new companion device.

These devices may communicate with the messaging server 102 via a communications network, which may be any wired or wireless communications network that is configured to transmit data between the server 102 and any of the client devices (and/or between any of the client devices) using any suitable communication protocol.

Server 102 may also be connected with a business client 104. The business client 104 may be associated with a business and allows users (such as customers of the business, for example) to interact with the business using the messaging system (for example, communicate with the business, perform transactions, etc.). As a security mechanism to verify a user's identity, the business client 104 can cause a one-time password (OTP) to be transmitted to a user device (e.g., the other client devices shown in the system 100). OTP is a unique and temporary code used to verify a user's identity, usually when the user is logging into their account or performing a transaction (for example, with the business). This password may be a four or six-digit code (e.g., 9237 or A87K90) that changes each time the code is generated. However, the password may also include any other number of digits or may be provided in any other format. A common OTP use case is when a user opts in to receive verification codes from the business associated with the business client 104. When attempting to log in, the business client 104 may verify the user's identity and send a unique security code delivered directly via the server 102. As an example of the OTP process, the user may first initiate an action that triggers OTP generation. Examples of such actions may include a user attempting to create a new account, a user attempting to recover an account, or a user attempting to make a purchase (for example, through the business associated with the business client 104). When such an action is performed, the server 102 generates the OTP. The server 102 then sends the OTP to the user (for example, to a client device of the user). The user receives the OTP via the client device (for example, the OTP can be transmitted to the client device and presented as a message via the application installed on the client device. The user may then enter the OTP into the requesting interface to verify identity. The server 102 then verifies the user. If the entered OTP is correct, the user is granted access to complete their intended action. However, if the entered OTP is incorrect (for example, the user enters a different code than the one that was provided), the user is denied access, potentially preventing bad actors from performing critical actions.

The business client 104 may have the responsibility to indicate to server 102 that the message includes sensitive information. This may be accomplished in a number of different ways. For example, the business client 104 can set a flag indicating that the message includes sensitive information. The business client 104 can also indicate that the message includes sensitive information in any other suitable manner. Alternatively, the business client 104 can generate the message and the server 102 may analyze the message to determine if the message contains sensitive information. In the specific use case described herein (other use cases involving other types of sensitive information may also be applicable), the business client 104 may indicate that the message includes an OTP that is intended to be transmitted to a client device (or the server 102 may receive the message and determine that the message includes an OTP).

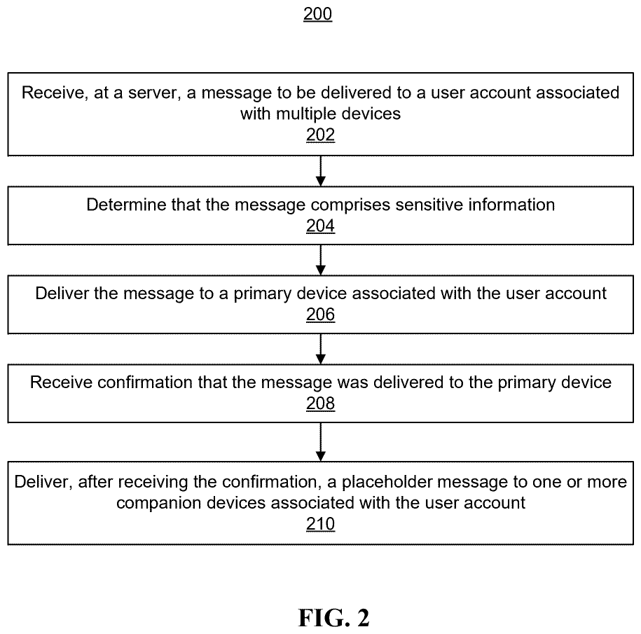

As shown in FIG. 1B, the messaging server 102 includes a message processing module 112, a device management module 114, or a database 116. The message processing module 112 may be responsible for analyzing incoming messages, determining if the message include sensitive information, or routing the message appropriately (further details about how such a determination is made are provided below with respect to at least FIG. 2). Sensitive information may include a one time password (OTP), verification code, or the like which may be associated with authentication or authorization. The device management module 114 may maintain information about which devices are associated with each user account and their designated roles (primary or companion). The database 116 may store user account information, device associations, or message metadata. It is contemplated herein that one or more of the functionalities described herein may be one device or module or distributed over multiple devices or modules.

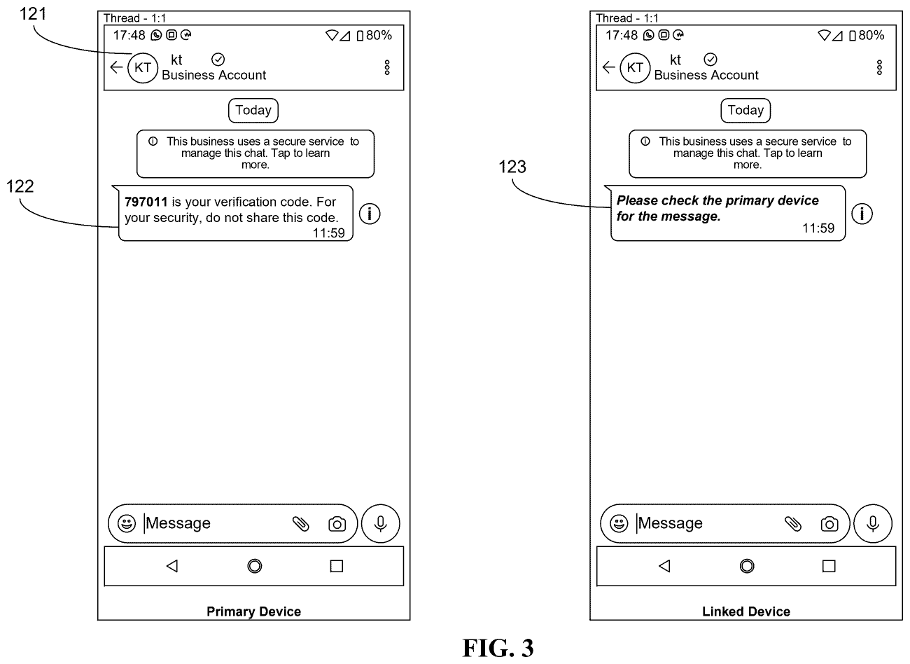

FIG. 2 illustrates a method 200 for processing or delivering sensitive messages. At step 202, the server 102 may receive a message to be delivered to a user account 121 associated with multiple devices. For example, as shown in FIG. 3, the user account 121 may be “KT,” with primary device 302 and companion device 304 (or any other number of companion devices). As indicated above, although FIG. 3 shows interfaces presented on smartphones (that is, the primary device 302 and companion device 304 are smartphones), these devices may also be any other types of devices.

In step 204, the server 102 may determine whether the message may include sensitive information. This determination may be based on various factors, such as the presence of a sensitive content flag (which may be set by the sender or user) and/or the message type (e.g., if the message is an OTP message). The indicator of sensitive content may comprise a flag in the message metadata, for example, or the flag may be included in any other part of the data transmission. The determination may also be made in any other suitable manner. For example, the server 102 may perform an analysis of the contents of the message to determine whether the message contains sensitive information (for example, the server 102 may determine that the message contains an OTP and may then classify the message as containing sensitive information (however, there may be other types of sensitive information that the server 102 may be configured to identify. In some instances, however, it may be desirable for the contents of the message to remain private, and thus the server 102 may not have access to the contents of the message, but may instead rely on metadata or other indicators, as described above.

The determination is not necessarily limited to being performed by the server 102, however, and may be performed by any other device as well. For example, in some instances, the server 102 may initially send the message to the primary device 106 and the primary device 106 may determine if the message includes sensitive information (in any manner described herein or otherwise). The primary device 106 may then cause the placeholder message 123 to be presented on any companion devices 108 based on this determination. For example, the primary device 106 may send a notification to the server 102 and the server 102 may then send the placeholder message 123 to the companion devices 108 or otherwise cause the placeholder message 123 to be presented via the companion devices 108. Alternatively, the primary device 106 itself may send the placeholder message 123 to the companion devices 108 or otherwise cause the placeholder message 123 to be presented via the companion devices 108.

If the message is determined to include sensitive information, the server 102 may deliver the full message to the primary device 106 at step 206. The server 102 may then wait (set a timer) for a threshold period to receive confirmation of delivery from the primary device 106 at step 208. That is, upon receipt of the message, the primary device 106 itself may transmit an acknowledgement message to the server 102 confirm receipt of the message from the server 102. In some instances, the timer may be static and the same for any message with sensitive information that is transmitted to a primary device. However, the timer may also be dynamic and automatically adjusted by the system based on various factors. In some instances, a user (such as a user associated with the business client 104) may manually configure a specific timer to use. Additionally, different timers may be used in different instances by the same user. For example, a business client 104 may configure one timer for transaction verifications that is shorter than a timer for user account login.

When confirmation is received, the server 102 may generate or send a placeholder message 123 to the companion device 108 at step 210. This placeholder message 123 may notify companion device 108 that a sensitive message 122 was received at primary device 106 but does not include the sensitive information.

An example of such a placeholder message 123 is shown in FIG. 3. The example illustrated in FIG. 3 depicts two user interfaces presented on two different devices. A first user interface is presented via a messaging application installed on a primary device 302. Accordingly, the first user interface shows an example of a sensitive message 122. Particularly, this example shows a message including an OTP (“797011”) that the user can use for identity verification to perform some action (e.g., logging into an account, facilitating a transaction, etc.). The second user interface is presented via the messaging application installed on a companion device 304. Particularly, the second user interface shows the placeholder message 123 with the text “Please check the primary device for the message,” indicating that the user should check the messaging application installed on the primary device 302 to obtain the OTP sent to the messaging application on the primary device 304. This same message may also be sent to any other number of companion devices associated with the same user account as the primary device 302. As mentioned below, the placeholder message 123 may be transmitted as a multicast communication such that the placeholder message 123 reaches any other companion devices associated with the same user account that are unknown to the server 102.

It should be noted that the specific text included in the placeholder message 123 shown in FIG. 3 is merely exemplary and the placeholder message 123 may include any other text (or may also be provided in any other format).

In embodiments, the placeholder message 123 may be pre-generated and stored as a standardized message that a user would recognize as a message that is being transmitted by the messaging system (e.g., associated with the server 102), rather than a message received from another device (e.g., from another user). This serves as a mechanism to verify for the user that the placeholder message 123 is a legitimate message from the server 102. The placeholder message 123 may either be stored at the server 102 and transmitted to each companion device 108 or may be stored at the companion devices 108 themselves, and the server 102 may send an indication for the companion devices 108 to present the placeholder messages 123 via the messaging application.

In embodiments, the primary device 106 and companion devices may also be prevented from synchronizing the specific sensitive message 122 and placeholder message 123 with each other. In some instances, the primary device 106 and companion devices (e.g., any devices associated with a given user account) may otherwise generally be configured for message synchronization, such that the user can view some or all messages that have been transmitted regardless of the device that they are currently viewing (that is, the user can view the same messages on the primary device 106 or any companion device). This provides a convenient mechanism that eliminates the need for the user to view specific devices to read certain messages that were sent to and/or received from those specific devices (if the user is using various devices to send messages throughout a period of time). In some instances, this synchronization may be performed at the server 102.

The primary device 106 and companion devices may be prevented from synchronizing the specific sensitive message 122 and placeholder message 123 in various ways. As one example, the server 102 may transmit an indication to the primary device 106 that any companion devices that the sensitive message 122 and the placeholder message 123 should not be synchronized between the devices (but that other messages can still be synchronized). The server 102 may provide this indication in any suitable manner. As one example, the server may set a flag that is included in a transmission of the sensitive message 122, the flag indicating that the sensitive message 122 should not be synchronized. Likewise, the server 102 may set a flag that is included in a transmission of the placeholder message 123, the flag also indicating that the placeholder message 123 should not be synchronized. The server 102 may also indicate to the primary device 106 and any companion devices 108 that the sensitive message 122 and the placeholder message 123 should not be synchronized in any other suitable manner.

Alternatively, the determination that the sensitive message 122 and the placeholder message 123 should not be synchronized between the primary device 106 and any companion devices may be a local determination made by the devices themselves (rather than a determination made by the server 102 and communicated to the devices). For example, the primary device 106 and any companion devices may be configured to perform any of the analyses described herein (or otherwise) to determine if a message is a sensitive message 122 or a placeholder message 123. If the primary device 106 determines that a message it receives is a sensitive message 122, then the primary device 106 may prevent synchronization of that specific message. Likewise, if a companion device 108 determines that a message it receives is a placeholder message 123, then the companion device may prevent synchronization of that specific message. The primary device 106 and companion devices may continue to synchronize other messages, assuming message synchronization is enabled.

In scenarios in which the message does not include sensitive information, the message may be delivered to associated companion devices at step 212. That is, unless the message is determined to have sensitive information, the message can be transmitted to all of the devices associated with the user account. It is contemplated that other devices may execute some or all of the disclosed steps herein.

In embodiments, the sensitive message 112 may specifically be transmitted from the messaging server 102 to the primary device 106 using a broadcast communication, and the placeholder message 123 may be transmitted to any companion devices using a multicast communication. Generally, a broadcast communication is known to be a communication that is transmitted to all devices on a network. In contrast, a multicast communication is known to be a communication that is transmitted to a specific device or group of devices. That is, the multicast communication intentionally targets a specific device or devices, and the broadcast communication attempts to reach any potential devices that can receive the communication. This approach may be used to ensure that all companion devices associated with a given primary device 106 receive the placeholder message 123. For example, there may be instances in which new companion devices are added and the server 102 may be unaware of these companion devices. Accordingly, if the server 102 were only to direct the placeholder message 123 to the known companion devices, then there may be one or more companion devices that do not receive the placeholder message 123. If a user is currently interacting with one of these new companion devices 108, then the user may not see the placeholder message 123, and then the user may not know to check the primary device 106 for the sensitive message 112 (and may simply believe that the sensitive message 122 was not transmitted). However, this is merely one exemplary approach for transmitting these messages and other approaches using other types of communications may also be implemented.

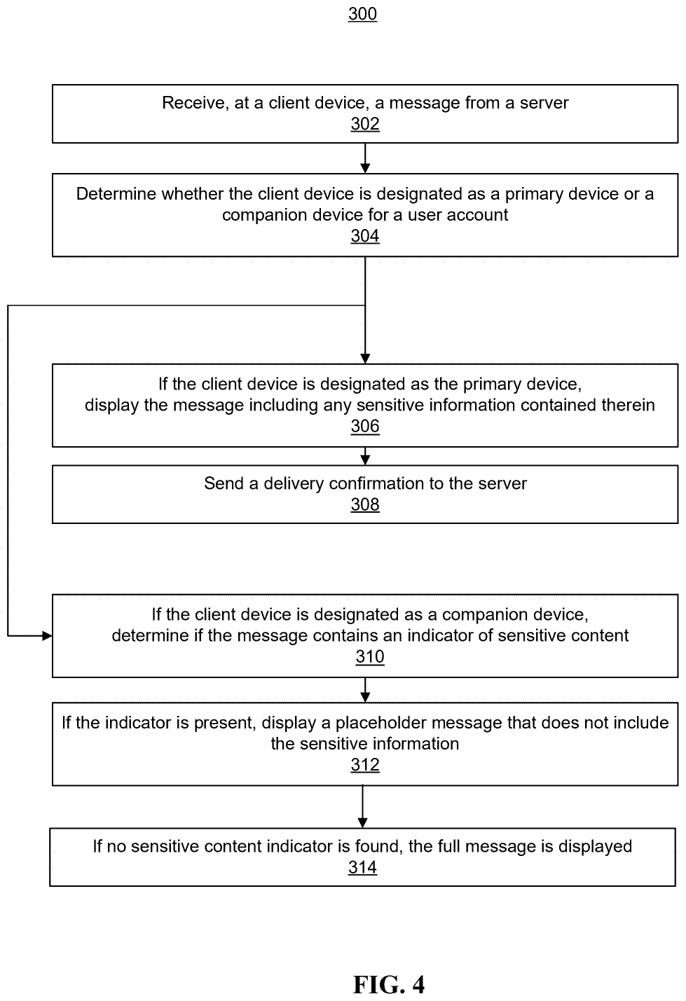

FIG. 4 illustrates an example method 300 for handling received messages from a client device perspective. At step 302, the client device 110 receives a message from the server. At step 304, the client device 110 checks its stored designation to determine whether it is a primary or companion device for the associated user account.

If the device is the primary device, it displays the full message content at step 306 and sends a delivery confirmation to the server 102 at step 308. If the client device 110 is a companion device, it checks for a sensitive content indicator at step 310. If the indicator is present, the client device 110 displays a placeholder message at step 312. If no sensitive content indicator is found, the full message is displayed at step 314.

The placeholder message may include text such as “A sensitive message was received. Please check your primary device.” This may help users be aware of incoming sensitive messages while maintaining security and privacy.

In some examples, a time-to-live (TTL) mechanism may be implemented for sensitive messages. If the primary device 106 does not confirm receipt within the TTL period, the server 102 may not send the placeholder message to companion devices 108, effectively dropping the message entirely.

The designation of a device as primary or companion may be done in various ways. In some implementations, the device used to create the user account may automatically be designated as the primary device. In another scenario, users 121 may manually designate their primary device through account settings. There should only be one primary device. Therefore, there may be periodic check to ensure that there is only one primary device for an associated user account. It is contemplated herein that other devices may execute some or all of the disclosed steps.

A method, system, or apparatus may provide for receiving, at a server, a message to be delivered to a user account associated with multiple devices; determining that the message contains sensitive information; delivering the message containing the sensitive information to a primary device associated with the user account; receiving confirmation that the message was delivered to the primary device; and after receiving the confirmation, delivering a placeholder message to one or more companion devices associated with the user account, wherein the placeholder message does not contain the sensitive information. The sensitive information may comprise a one-time password. Determining that the message contains sensitive information may comprise detecting a flag in the message indicating it should only be delivered to the primary device. The placeholder message may comprise an indication to check the primary device. If confirmation of delivery to the primary device is not received within a time-to-live period, the placeholder message may not be delivered to the companion devices. A sender of the message may be charged only after confirmation of delivery to the primary device is received.

The primary device may be a mobile phone and the one or more companion devices may comprise at least one of a tablet, desktop computer, mobile phone, or wearable device. All combinations (including the removal or addition of steps) in this paragraph and the above paragraphs are contemplated in a manner that is consistent with the other portions of the detailed description.

A system may include a processor and a memory storing instructions that, when executed by the processor, cause the system to receive a message containing sensitive information to be delivered to a user account; deliver the message only to a primary device associated with the user account; receive a delivery confirmation from the primary device; and in response to receiving the delivery confirmation, transmit a masked version of the message to one or more companion devices associated with the user account. The masked version of the message may not contain the sensitive information. If the delivery confirmation is not received within a specified time period, the masked version may not be transmitted to the companion devices. The system may receive an indication that the message should only be delivered to the primary device. The primary device may be designated by a user of the account. All combinations (including the removal or addition of steps) in this paragraph and the above paragraphs are contemplated in a manner that is consistent with the other portions of the detailed description.

A non-transitory computer-readable storage medium may store instructions that, when executed by a processor, cause the processor to receive a request to send a message containing a one-time password to a user account; transmit the message to a primary device associated with the user account; receive an acknowledgement of delivery to the primary device; and in response to receiving the acknowledgement, transmit a notification message to one or more companion devices associated with the user account, wherein the notification message does not contain the one-time password. If the acknowledgement is not received within a time-to-live period, the notification message may not be transmitted. A charge for sending the message may be recorded only after receiving the acknowledgement. The notification message may indicate to check the primary device for the one-time password. The primary device may be designated based on which device was used to create the user account. All combinations (including the removal or addition of steps) in this paragraph and the above paragraphs are contemplated in a manner that is consistent with the other portions of the detailed description.

Methods, systems, or apparatus for handling messages at client devices are disclosed herein. A method, system, or apparatus may provide for receiving, at a client device, a message from a server; determining whether the client device is designated as a primary device or a companion device for a user account; if the client device is designated as the primary device: displaying the message including any sensitive information contained therein, and sending a delivery confirmation to the server; if the client device is designated as a companion device: determining if the message contains an indicator of sensitive content, and if the indicator is present, displaying a placeholder message that does not include the sensitive information. The sensitive information may comprise a one-time password. The placeholder message may comprise an instruction to check the primary device. If the client device is the primary device, an acknowledgement may be sent to the server upon displaying the message. Determining whether the client device is designated as a primary device or a companion device may comprise checking a stored device status indicator. The indicator of sensitive content may comprise a flag in the message metadata. All combinations (including the removal or addition of steps) in this paragraph and the above paragraphs are contemplated in a manner that is consistent with the other portions of the detailed description.

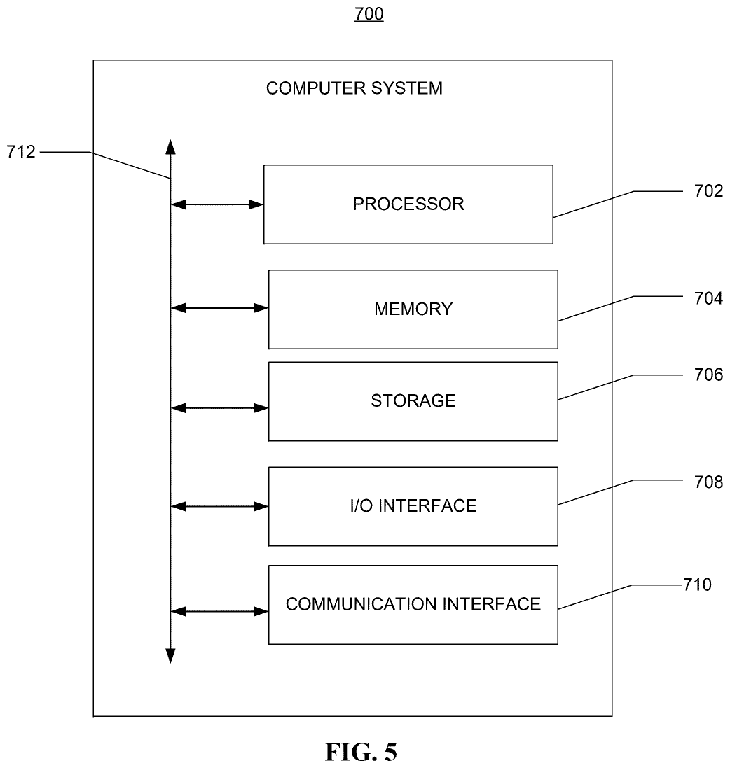

FIG. 5 illustrates an example computer system 700. In examples, one or more computer systems 700 perform one or more steps of one or more methods described or illustrated herein. In particular embodiments, one or more computer systems 700 provide functionality described or illustrated herein. In examples, software running on one or more computer systems 700 performs one or more steps of one or more methods described or illustrated herein or provides functionality described or illustrated herein. Examples include one or more portions of one or more computer systems 700. Herein, reference to a computer system may encompass a computing device, and vice versa, where appropriate. Moreover, reference to a computer system may encompass one or more computer systems, where appropriate.

This disclosure contemplates any suitable number of computer systems 700. This disclosure contemplates computer system 700 taking any suitable physical form. As example and not by way of limitation, computer system 700 may be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, a tablet computer system, or a combination of two or more of these. Where appropriate, computer system 700 may include one or more computer systems 700; be unitary or distributed; span multiple locations; span multiple machines; span multiple data centers; or reside in a cloud, which may include one or more cloud components in one or more networks. Where appropriate, one or more computer systems 700 may perform without substantial spatial or temporal limitation one or more steps of one or more methods described or illustrated herein. As an example, and not by way of limitation, one or more computer systems 700 may perform in real time or in batch mode one or more steps of one or more methods described or illustrated herein. One or more computer systems 700 may perform at different times or at different locations one or more steps of one or more methods described or illustrated herein, where appropriate.

In examples, computer system 700 includes a processor 702, memory 704, storage 706, an input/output (I/O) interface 708, a communication interface 710, and a bus 712 (e.g., communication bus 103). Although this disclosure describes and illustrates a particular computer system having a particular number of particular components in a particular arrangement, this disclosure contemplates any suitable computer system having any suitable number of any suitable components in any suitable arrangement.

In examples, processor 702 includes hardware for executing instructions, such as those making up a computer program. As an example, and not by way of limitation, to execute instructions, processor 702 may retrieve (or fetch) the instructions from an internal register, an internal cache, memory 704, or storage 706; decode and execute them; and then write one or more results to an internal register, an internal cache, memory 704, or storage 706. In particular embodiments, processor 702 may include one or more internal caches for data, instructions, or addresses. This disclosure contemplates processor 702 including any suitable number of any suitable internal caches, where appropriate. As an example, and not by way of limitation, processor 702 may include one or more instruction caches, one or more data caches, and one or more translation lookaside buffers (TLBs).

Instructions in the instruction caches may be copies of instructions in memory 704 or storage 706, and the instruction caches may speed up retrieval of those instructions by processor 702. Data in the data caches may be copies of data in memory 704 or storage 706 for instructions executing at processor 702 to operate on; the results of previous instructions executed at processor 702 for access by subsequent instructions executing at processor 702 or for writing to memory 704 or storage 706; or other suitable data. The data caches may speed up read or write operations by processor 702. The TLBs may speed up virtual-address translation for processor 702. In particular embodiments, processor 702 may include one or more internal registers for data, instructions, or addresses. This disclosure contemplates processor 702 including any suitable number of any suitable internal registers, where appropriate. Where appropriate, processor 702 may include one or more arithmetic logic units (ALUs); be a multi-core processor; or include one or more processors 702. Although this disclosure describes and illustrates a particular processor, this disclosure contemplates any suitable processor.

In examples, memory 704 includes main memory for storing instructions for processor 702 to execute or data for processor 702 to operate on. As an example, and not by way of limitation, computer system 700 may load instructions from storage 706 or another source (such as, for example, another computer system 700) to memory 704. Processor 702 may then load the instructions from memory 704 to an internal register or internal cache. To execute the instructions, processor 702 may retrieve the instructions from the internal register or internal cache and decode them. During or after execution of the instructions, processor 702 may write one or more results (which may be intermediate or final results) to the internal register or internal cache. Processor 702 may then write one or more of those results to memory 704. In particular embodiments, processor 702 executes only instructions in one or more internal registers or internal caches or in memory 704 (as opposed to storage 706 or elsewhere) and operates only on data in one or more internal registers or internal caches or in memory 704 (as opposed to storage 706 or elsewhere). One or more memory buses (which may each include an address bus and a data bus) may couple processor 702 to memory 704. Bus 712 may include one or more memory buses, as described below. In examples, one or more memory management units (MMUs) reside between processor 702 and memory 704 and facilitate accesses to memory 704 requested by processor 702. In particular embodiments, memory 704 includes random access memory (RAM). This RAM may be volatile memory, where appropriate. Where appropriate, this RAM may be dynamic RAM (DRAM) or static RAM (SRAM). Moreover, where appropriate, this RAM may be single-ported or multi-ported RAM. This disclosure contemplates any suitable RAM. Memory 704 may include one or more memories 704, where appropriate. Although this disclosure describes and illustrates particular memory, this disclosure contemplates any suitable memory.

In examples, storage 706 includes mass storage for data or instructions. As an example, and not by way of limitation, storage 706 may include a hard disk drive (HDD), a floppy disk drive, flash memory, an optical disc, a magneto-optical disc, magnetic tape, or a Universal Serial Bus (USB) drive or a combination of two or more of these. Storage 706 may include removable or non-removable (or fixed) media, where appropriate. Storage 706 may be internal or external to computer system 700, where appropriate. In examples, storage 706 is non-volatile, solid-state memory. In particular embodiments, storage 706 includes read-only memory (ROM). Where appropriate, this ROM may be mask-programmed ROM, programmable ROM (PROM), erasable PROM (EPROM), electrically erasable PROM (EEPROM), electrically alterable ROM (EAROM), or flash memory or a combination of two or more of these. This disclosure contemplates mass storage 706 taking any suitable physical form. Storage 706 may include one or more storage control units facilitating communication between processor 702 and storage 706, where appropriate. Where appropriate, storage 706 may include one or more storages 706. Although this disclosure describes and illustrates particular storage, this disclosure contemplates any suitable storage.

In examples, I/O interface 708 includes hardware, software, or both, providing one or more interfaces for communication between computer system 700 and one or more I/O devices. Computer system 700 may include one or more of these I/O devices, where appropriate. One or more of these I/O devices may enable communication between a person and computer system 700. As an example, and not by way of limitation, an I/O device may include a keyboard, keypad, microphone, monitor, mouse, printer, scanner, speaker, still camera, stylus, tablet, touch screen, trackball, video camera, another suitable I/O device or a combination of two or more of these. An I/O device may include one or more sensors. This disclosure contemplates any suitable I/O devices and any suitable I/O interfaces 708 for them. Where appropriate, I/O interface 708 may include one or more device or software drivers enabling processor 702 to drive one or more of these I/O devices. I/O interface 708 may include one or more I/O interfaces 708, where appropriate. Although this disclosure describes and illustrates a particular I/O interface, this disclosure contemplates any suitable I/O interface.

In examples, communication interface 710 includes hardware, software, or both providing one or more interfaces for communication (such as, for example, packet-based communication) between computer system 700 and one or more other computer systems 700 or one or more networks. As an example, and not by way of limitation, communication interface 710 may include a network interface controller (NIC) or network adapter for communicating with an Ethernet or other wire-based network or a wireless NIC (WNIC) or wireless adapter for communicating with a wireless network, such as a WI-FI network. This disclosure contemplates any suitable network and any suitable communication interface 710 for it. As an example, and not by way of limitation, computer system 700 may communicate with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, computer system 700 may communicate with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination of two or more of these. Computer system 700 may include any suitable communication interface 710 for any of these networks, where appropriate. Communication interface 710 may include one or more communication interfaces 710, where appropriate. Although this disclosure describes and illustrates a particular communication interface, this disclosure contemplates any suitable communication interface.

In particular embodiments, bus 712 includes hardware, software, or both coupling components of computer system 700 to each other. As an example and not by way of limitation, bus 712 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination of two or more of these. Bus 712 may include one or more buses 712, where appropriate. Although this disclosure describes and illustrates a particular bus, this disclosure contemplates any suitable bus or interconnect.

Herein, a computer-readable non-transitory storage medium or media may include one or more semiconductor-based or other integrated circuits (ICs) (such, as for example, field-programmable gate arrays (FPGAs) or application-specific ICs (ASICs)), hard disk drives (HDDs), hybrid hard drives (HHDs), optical discs, optical disc drives (ODDs), magneto-optical discs, magneto-optical drives, floppy diskettes, floppy disk drives (FDDs), magnetic tapes, solid-state drives (SSDs), RAM-drives, SECURE DIGITAL cards or drives, any other suitable computer-readable non-transitory storage media, computer readable medium or any suitable combination of two or more of these, where appropriate. A computer-readable non-transitory storage medium may be volatile, non-volatile, or a combination of volatile and non-volatile, where appropriate.

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

While the disclosed systems have been described in connection with the various examples of the various figures, it is to be understood that other similar implementations may be used or modifications and additions may be made to the described examples of a robotic skin or AI robotics platform, among other things as disclosed herein. For example, one skilled in the art will recognize that robotic skin or AI robotics platform, among other things as disclosed herein in the instant application may apply to any environment, whether wired or wireless, and may be applied to any number of such devices connected via a communications network and interacting across the network. Therefore, the disclosed systems as described herein should not be limited to any single example, but rather should be construed in breadth and scope in accordance with the appended claims.

In describing preferred methods, systems, or apparatuses of the subject matter of the present disclosure—masking high security messages on companion devices—as illustrated in the Figures, specific terminology is employed for the sake of clarity. The claimed subject matter, however, is not intended to be limited to the specific terminology so selected.

Also, as used in the specification including the appended claims, the singular forms “a,” “an,” and “the” include the plural, and reference to a particular numerical value includes at least that particular value, unless the context clearly dictates otherwise. The term “plurality”, as used herein, means more than one. When a range of values is expressed, another embodiment includes from the one particular value or to the other particular value. Similarly, when values are expressed as approximations, by use of the antecedent “about,” it will be understood that the particular value forms another embodiment. All ranges are inclusive and combinable. It is to be understood that the terminology used herein is for the purpose of describing particular aspects only and is not intended to be limiting.

This written description uses examples to enable any person skilled in the art to practice the claimed subject matter, including making and using any devices or systems and performing any incorporated methods. Other variations of the examples are contemplated herein. It is to be appreciated that certain features of the disclosed subject matter which are, for clarity, described herein in the context of separate embodiments, may also be provided in combination in a single embodiment.

Conversely, various features of the disclosed subject matter that are, for brevity, described in the context of a single embodiment, may also be provided separately or in any sub-combination. Further, any reference to values stated in ranges includes each and every value within that range. Any documents cited herein are incorporated herein by reference in their entireties for any and all purposes.

The scope of this disclosure encompasses all changes, substitutions, variations, alterations, and modifications to the example embodiments described or illustrated herein that a person having ordinary skill in the art would comprehend. The scope of this disclosure is not limited to the examples described or illustrated herein. Moreover, although this disclosure describes and illustrates respective embodiments herein as including particular components, elements, feature, functions, operations, or steps, any of these embodiments may include any combination or permutation of any of the components, elements, features, functions, operations, or steps described or illustrated anywhere herein that a person having ordinary skill in the art would comprehend. Furthermore, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative. Additionally, although this disclosure describes or illustrates particular embodiments as providing particular advantages, particular embodiments may provide none, some, or all of these advantages.

That which is claimed is:

1. A method comprising:
receiving, at a server, a message to be delivered to a user account associated with multiple devices;
determining that the message comprises sensitive information;
delivering, based on determining that the message comprises sensitive information, the message to a primary device associated with the user account;
receiving confirmation that the message was delivered to the primary device; and
delivering, after receiving the confirmation, a placeholder message to one or more companion devices associated with the user account, wherein the placeholder message does not include the sensitive information.

2. The method of claim 1, wherein the sensitive information comprises a one-time password.

3. The method of claim 1, wherein determining that the message contains sensitive information comprises detecting a flag in the message.

4. The method of claim 1, wherein the placeholder message comprises an indication to check the primary device to view the message.

5. The method of claim 1, wherein delivering the message to the primary device is performed as a multicast communication.

6. The method of claim 1, wherein delivering the placeholder message is performed as a broadcast communication.

7. The method of claim 1, further comprising:
charging a sender of the message only after confirmation of delivery to the primary device is received.

8. The method of claim 1, wherein the primary device is a mobile phone and the one or more companion devices comprise at least one of a tablet, desktop computer, mobile phone, or wearable device.

9. A device comprising:
a processor; and
a memory storing instructions that, when executed by the processor, cause the device to:
receive a message containing sensitive information to be delivered to a user account;
deliver, based on determining that the message comprises sensitive information, the message to a primary device associated with the user account;
receive a delivery confirmation from the primary device; and
in response to receiving the delivery confirmation, transmit a masked version of the message to one or more companion devices associated with the user account.

10. The device of claim 9, wherein the masked version of the message does not contain the sensitive information.

11. The device of claim 9, wherein delivering the message to the primary device is performed as a multicast communication.

12. The device of claim 9, wherein delivering the masked version of the message is performed as a broadcast communication.

13. The device of claim 9, wherein the instructions further cause the device to receive an indication that the message should only be delivered to the primary device.

14. The device of claim 9, wherein the primary device is designated by a user of the account or the device the user initially registered.

15. A non-transitory computer-readable storage medium storing instructions that, when executed by a processor, cause the processor to:
receive a request to send a message containing a one-time password to a user account;
transmit the message to a primary device associated with the user account;
receive an acknowledgement of delivery to the primary device; and
in response to receiving the acknowledgement, transmit a notification message to one or more companion devices associated with the user account, wherein the notification message does not contain the one-time password.

16. The non-transitory computer-readable storage medium of claim 15, wherein the instructions further cause the processor to:
if the acknowledgement is not received within a time-to-live period, not transmit the notification message.

17. The non-transitory computer-readable storage medium of claim 15, wherein the instructions further cause the processor to:
record a charge for sending the message only after receiving the acknowledgement.

18. The non-transitory computer-readable storage medium of claim 15, wherein the notification message indicates to check the primary device for the one-time password.

19. The non-transitory computer-readable storage medium of claim 15, wherein the primary device is designated based on which device was used to create the user account.

20. The non-transitory computer-readable storage medium of claim 15, wherein delivering the message to the primary device is performed as a multicast communication, and wherein delivering the notification message is performed as a broadcast communication.
